(19) United States
(12) Patent Application Publication
(10) Pub. No.: US 2015/0357874 A1
(43) Pub. Date: Dec. 10, 2015

(54) SPINDLE MOTOR AND RECORDING DISK DRIVING APPARATUS INCLUDING THE SAME

(71) Applicant: SAMSUNG ELECTRONICS-MECHANICS CO., LTD., Suwon-Si (KR)

(72) Inventor: Hyuk Joo KIM, Suwon-Si (KR)

(73) Assignee: SAMSUNG ELECTRONICS-MECHANICS CO., LTD., Suwon-Si (KR)

(21) Appl. No.: 14/603,361

(22) Filed: Jan. 23, 2015

(30) Foreign Application Priority Data
Jun. 10, 2014 (KR) 10-2014-0069906

(51) Int. Cl. H02K 5/16; G11B 19/20

(52) U.S. Cl. CPC H02K 5/161; G11B 19/2009

(57) ABSTRACT

There is provided a spindle motor including: a base member including a bend portion; an installation member having an insertion groove formed therein and a stator core fixed thereto, the insertion groove having the bend portion inserted thereinto; and a sleeve fixed to an inner peripheral surface of the installation member.

### CROSS-REFERENCE TO RELATED APPLICATION

This application claims the priority and benefit of

Korean Patent Application No. 10-2014-0069906 filed on Jun. 10, 2014, with the Korean Intellectual Property Office, the disclosure of which is incorporated herein by reference.

### BACKGROUND

The present disclosure relates to a spindle motor and a recording disk driving apparatus including the same.

A hard disk drive (HDD), a computer information storage apparatus, reads data stored on a disk or writes data to a disk using a magnetic head.

In such a hard disk drive, a base plate is provided with a head driver, that is, a head stack assembly (HSA), capable of moving the magnetic head across the disk. The magnetic head functions while moving to a desired position in a state in which it is suspended above a writing surface of the disk at a predetermined height by the head driver.

In the related art, in manufacturing a base plate provided in the hard disk drive, a post-processing scheme of die-casting aluminum (Al) and then removing flash, or the like, generated due to the die-casting has been used.

However, in the die-casting scheme according to the related art, a process of injecting aluminum (Al) for forging in a molten state to form a cast component is performed and thus, high levels of temperature and pressure are required, such that a large amount of energy is required in the process and a process time may be increased.

Further, in terms of a lifespan of a die-casting mold, there is a limitation in manufacturing a large number of base plates using a single mold, and a base plate manufactured by the die-casting process has poor dimensional precision.

Therefore, the base plate has been manufactured by a pressing or forging method in order to solve such problems in the die-casting process. That is, the base member is formed by performing plastic deformation (for example, press working) on a steel sheet.

However, in the case in which the base member is formed using the steel sheet, rust may be generated due to corrosion of the steel sheet. Therefore, in this case, a coating layer is generally formed on the base member.

Therefore, coupling force between the base member and a sleeve, an installation member, and the like, may be decreased due to the coating layer. In other words, the sleeve and the installation member coupled to the base member may be separated from the base member at the time of an external impact.

In addition, since the base member is formed by press working, it may not be easy to manage perpendicularity of a shaft.

As a result, the development of a structure allowing for perpendicularity of the shaft to be easily managed while increasing coupling force between components coupled to each other has been urgently demanded.

### RELATED ART DOCUMENT

(Patent Document 1) Japanese Patent Laid-Open Publication No. 2009-142019

### SUMMARY

An aspect of the present disclosure may provide a spindle motor capable of decreasing separation of an installation member, and a recording disk driving apparatus including the same.

An aspect of the present disclosure may also provide a spindle motor capable of improving precision of assembling, and a recording disk driving apparatus including the same.

According to an aspect of the present disclosure, a spindle motor may include: a base member including a bend portion; an installation member having an insertion groove formed therein and a stator core fixed thereto, the insertion groove having the bend portion inserted thereinto; and a sleeve fixed to an inner peripheral surface of the installation member.

The insertion groove may be recessed from a lower surface of the installation member in an upward axial direction.

The bend portion may be bonded to an inner wall surface, an outer wall surface, and a ceiling surface forming the insertion groove.

The installation member may have a bonding groove formed in a lower end portion of an inner diameter part thereof in order to be bonded to the sleeve.

The sleeve may have a step groove formed in a lower end portion of an outer peripheral surface thereof, the step groove being welded together with the bonding groove.

The inner peripheral surface of the installation member may have a roughness rougher than those of other portions.

The spindle motor may further include: a shaft inserted into a shaft hole of the sleeve; a rotor hub fixed to an upper end portion of the shaft to thereby be rotated together with the shaft; and a cover member installed at a lower end portion of the sleeve and preventing leakage of a lubricating fluid.

The installation member may be bonded to the base member through an adhesive.

The bend portion may have an adhesive accommodating groove formed in a lower end portion thereof in order to accommodate an adhesive therein.

According to another aspect of the present disclosure, a recording disk driving apparatus may include: the spindle motor as described above; a head transfer part transferring a head reading information from and writing information to the recording disk mounted on the spindle motor; and an upper case coupled to the base member provided in the spindle motor so as to form an internal space accommodating the spindle motor and the head transfer part therein.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view showing a spindle motor according to an exemplary embodiment of the present disclosure;

FIG. 2 is an enlarged view of part A of FIG. 1;

FIG. 3 is a bottom perspective view showing an installation member of the spindle motor according to an exemplary embodiment of the present disclosure;

FIG. 4 is a bottom perspective view showing an installation member provided in a spindle motor according to another exemplary embodiment of the present disclosure; and

FIG. 5 is a schematic cross-sectional view showing a recording disk driving apparatus according to an exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

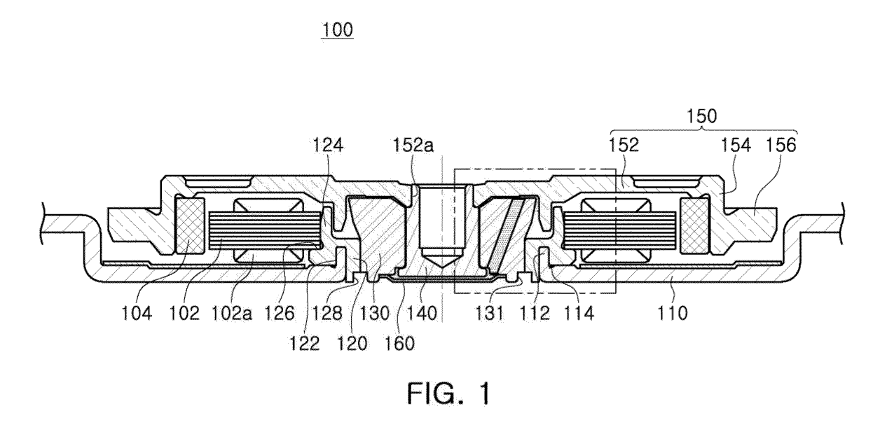

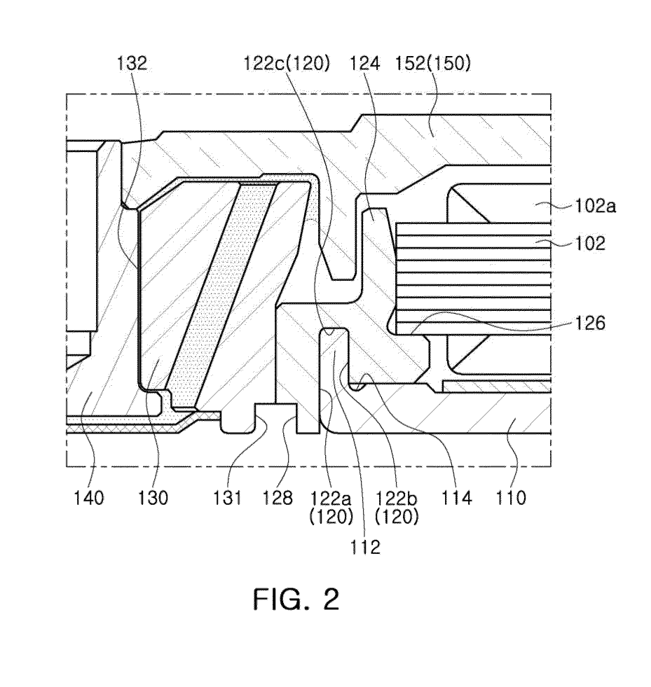

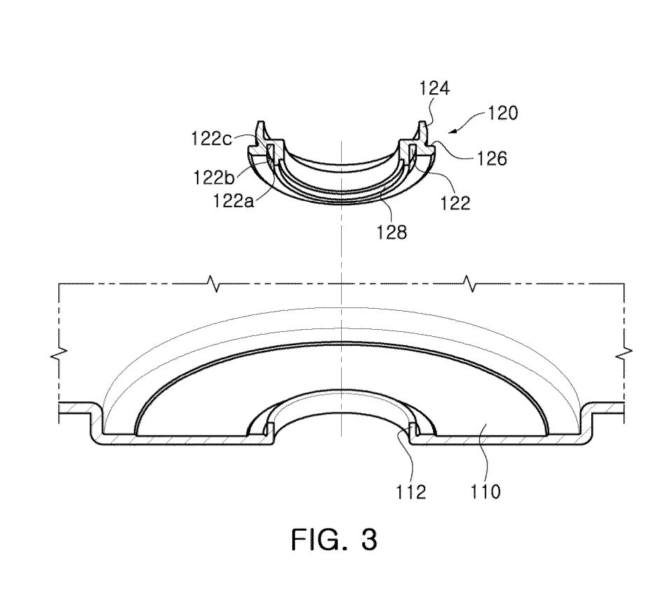

FIG. 1 is a schematic cross-sectional view showing a spindle motor according to an exemplary embodiment of the present disclosure; FIG. 2 is an enlarged view of part A of FIG. 1; and FIG. 3 is a bottom perspective view showing an installation member of the spindle motor according to an exemplary embodiment of the present disclosure.

Referring to FIGS. 1 through 3, a spindle motor 100 according to an exemplary embodiment of the present disclosure may include a base member 110, an installation member 120, a sleeve 130, a shaft 140, a rotor hub 150, and a cover member 160 by way of example.

Meanwhile, the spindle motor 100 according to an exemplary embodiment of the present disclosure may be used in a recording disk driving apparatus to be described below.

The base member 110 may include a bend portion 112. Meanwhile, the base member 110 may be formed by press working by way of example. That is, the base member 110 may be formed by performing plastic deformation (that is, press working) on a steel sheet.

Meanwhile, the bend portion 112 may protrude in an upward axial direction, and may be bonded to the above-mentioned installation member 120. A detailed description therefor will be provided below.

In addition, the base member 110 may have an adhesive accommodating groove 114 formed at a lower end portion of the bend portion 112 thereof in order to accommodate an adhesive therein. That is, in the case in which the installation member 120 is installed in the base member 110 by the adhesive, the adhesive may be accommodated in the adhesive accommodating groove 114 to increase coupling force between the installation member 120 and the base member 110.

Here, terms with respect to directions will be defined. As viewed in FIG. 1, an axial direction refers to a vertical direction, that is, a direction from a lower end portion of the shaft 140 toward an upper end portion thereof or a direction from the upper end portion of the shaft 140 toward the lower end portion thereof, and a radial direction refers to a horizontal direction, that is, a direction from an outer peripheral surface of the rotor hub 150 toward the shaft 140 or a direction from the shaft 140 toward the outer peripheral surface of the rotor hub 150.

In addition, a circumferential direction refers to a rotation direction along an outer peripheral direction of the shaft 140.

The installation member 120 may have an insertion groove 122 formed therein, wherein the insertion groove 122 has the bend portion 112 inserted thereinto. The insertion groove 122 may be recessed from a lower surface of the installation member 120 in the upward axial direction. Meanwhile, the bend portion 112 of the base member 110 may contact at least two of an inner wall surface 122a, an outer wall surface 122b, and a ceiling surface 122c of the installation member 120 forming the insertion groove 122. In addition, the bend portion 112 may be fixed to the insertion groove 122 of the installation member 120 by the adhesive.

As described above, since the bend portion 112 is inserted into and coupled to the insertion groove 122 formed in the installation member 120, the bend portion 112 and the installation member 120 may be bonded to each other on at least two surfaces, such that coupling force between the installation member 120 and the base member 110 may be increased.

In other words, an inner peripheral surface and an outer peripheral surface of the bend portion 112 may be bonded to the inner wall surface 122a and the outer wall surface 122b of the installation member 120, respectively, such that a bonded area is increased, thereby increasing the coupling force.

Meanwhile, the installation member 120 may have a stator core 102 fixed thereto. To this end, the installation member 120 may include a support wall part 124 supporting an inner diameter part of the stator core 102 and a support surface 126.

That is, the stator core 102 may be installed on the installation member 120 through an adhesive in a state in which it is seated on the support surface 126.

In addition, an inner peripheral surface of the installation member 120 may have a roughness rougher than those of other portions. That is, the inner peripheral surface of the installation member 120 may be bonded to an outer peripheral surface of the sleeve 130 by an adhesive, and may be formed so as to have a rough roughness in order to increase coupling force between the installation member 120 and the sleeve 130.

Therefore, the coupling force between the sleeve 130 and the installation member 120 may be increased.

In addition, the installation member 120 may have a bonding groove 128 formed at a lower end portion of an inner diameter part thereof in order to be bonded to the sleeve 130. The bonding groove 128 may have a solder ball inserted thereinto at the time of welding the installation member 120 and the sleeve 130 to each other.

That is, the installation member 120 and the sleeve 130 may be coupled to each other by the adhesive and the welding. In other words, the inner peripheral surface of the installation member 120 may be bonded to the outer peripheral surface of the sleeve 130 by the adhesive, and lower surfaces of the installation member 120 and the sleeve 130 may be bonded to each other by the welding.

The sleeve 130 may be fixed to the inner peripheral surface of the installation member 120. That is, the inner peripheral surface of the installation member 120 may be bonded to the outer peripheral surface of the sleeve 130. In addition, the sleeve 130 may have a step groove 131 formed at a lower end portion of the outer peripheral surface thereof, wherein the step groove 131 allows the solder ball to be inserted thereinto together with the above-mentioned bonding groove 128.

That is, the bonding groove 128 and the step groove 131 may be connected to each other at the time of coupling the installation member 120 and the sleeve 130 to each other, and welding may be performed on an internal space formed by the bonding groove 128 and the step groove 131.

Therefore, the solder ball by the welding may be inserted into the space formed by the bonding groove 128 and the step groove 131.

In addition, a plurality of bonding grooves 128 and step grooves 131 may be disposed in the circumferential direction so as to be spaced apart from each other, or the bonding groove 128 and the step groove 131 may be formed in a circular ring shape in the circumferential direction.

Meanwhile, the sleeve 130 may rotatably support the shaft 140. To this end, the sleeve 130 may include a shaft hole 132 formed therein, wherein the shaft hole 132 has the shaft 140 inserted thereinto. In other words, the sleeve 130 may have a hollow cylindrical shape.

In addition, in the case in which the shaft 140 is inserted into the sleeve 130, an inner peripheral surface of the sleeve 130 and an outer peripheral surface of the shaft 140 may be spaced apart from each other by a predetermined interval to form a bearing clearance therebetween. This bearing clearance may be filled with a lubricating fluid.

In addition, the sleeve 130 may have the cover member 160 installed at a lower end portion thereof in order to prevent the lubricating fluid filled in the bearing clearance from being leaked downwardly.

Here, the bearing clearances will be briefly described. The bearing clearances may be formed by the sleeve 130 and the shaft 140, the sleeve 130 and the rotor hub 150, the cover member 160 and sleeve 130, and the cover member 160 and the shaft 140 and be filled with the lubricating fluid.

That is, the spindle motor 100 according to an exemplary embodiment of the present disclosure may have a full-fill structure in which the lubricating fluid is filled in all of the above-mentioned bearing clearances.

Meanwhile, upper and lower radial dynamic grooves (not shown) may be formed in at least one of the inner peripheral surface of the sleeve 130 and the outer peripheral surface of the shaft 140. The upper and lower radial dynamic grooves may be disposed so as to be spaced apart from each other by a predetermined interval in the axial direction, and may generate fluid dynamic pressure in the radial direction at the time of rotation of the shaft 140. Therefore, the shaft 140 may be more stably rotated.

The shaft 140 may be rotatably installed in the sleeve 130. That is, the shaft 140 may be inserted into the shaft hole 132 of the sleeve 130. Further, the shaft 140 may have the rotor hub 150 fixed to an upper end portion thereof. To this end, the shaft 140 may be disposed so that the upper end portion thereof protrudes from the sleeve 130.

Meanwhile, the rotor hub 150 may be fixed to the upper end portion of the shaft 140, such that the shaft 140 and the rotor hub 150 may be rotated together with each other.

The rotor hub 150 may include a body 152 provided with a through-hole 152a into which the shaft 140 is inserted and having a disk shape, a magnet mounting part 154 extended from an edge of the body 152 in a downward axial direction, and a disk supporting part 156 extended from a distal end of the magnet mounting part 154 in the radial direction.

In addition, the magnet mounting part 154 may have a driving magnet 104 fixedly installed on an inner surface thereof. Therefore, an inner surface of the driving magnet 104 may be disposed so as to face a front end of the stator core 102.

Meanwhile, the driving magnet 104 may be a permanent magnet generating magnetic force having a predetermined strength by alternately magnetizing an N pole and an S pole thereof in the circumferential direction.

Here, a rotational driving scheme of the rotor hub 150 will be briefly described. When power is supplied to a coil 102a wound around the stator core 102, driving force rotating the rotor hub 150 may be generated by an electromagnetic interaction between the stator core 102 having the coil 102a wound therearound and the driving magnet 104 to rotate the rotor hub 150.

That is, the driving magnet 104 and the stator core 102 disposed so as to face the driving magnet 104 and having the coil 102a wound therearound may electromagnetically interact with each other to rotate the rotor hub 150.

The cover member 160 may be fixed to the lower end portion of the sleeve 130 in order to prevent leakage of the lubricating fluid. In addition, the cover member 160 may have a circular plate shape, and may be bonded to the lower end portion of the sleeve 130 by at least one of an adhering method and a welding method.

As described above, the bend portion 112 formed by the press working may be inserted into and coupled to the insertion groove 122 of the installation member 120, such that the coupling force between the base member 110 and the installation member 120 may be increased. In other words, the inner peripheral surface and the outer peripheral surface of the bend portion 112 may be bonded to the inner wall surface 122a and the outer wall surface 122b of the installation member 120, respectively, such that the bonded area is increased, thereby increasing the coupling force.

In addition, since perpendicularity of the shaft 140 may be adjusted by working the installation member 120 without relying on perpendicularity of the bend portion 112, the perpendicularity may be easily managed.

Further, the sleeve 130 is not bonded to the bend portion 112 formed by the press working, but may be bonded to installation member 120, such that the coupling force of the sleeve 130 may be increased.

In addition, since the roughness of the inner peripheral surface of the installation member 120 may be adjusted, the coupling force between the installation member 120 and the sleeve 130 may be further increased.

In addition, since the welding may be performed on regions in which the bonding groove 128 of the installation member 120 and the step groove 131 of the sleeve 130 are formed, the coupling force by the welding may be increased.

That is, in the related art, in the case of welding and bonding the sleeve 130 and the base member 110 to each other, it is not easy to weld and bond the sleeve 130 and the base member 110 to each other due to the coating layer coated on the base member 110. However, in the present disclosure, since the sleeve 130 and the installation member 120 are welded to each other, an influence by the coating layer may be excluded, such that the welding may be more easily performed, and the coupling force by the welding may be improved.

Hereinafter, an installation member provided in a spindle motor according to another exemplary embodiment of the present disclosure will be described with reference to the accompanying drawings. However, the same components that are the same as the components described above will be denoted by the same reference numerals, and a detailed description therefor will be omitted.

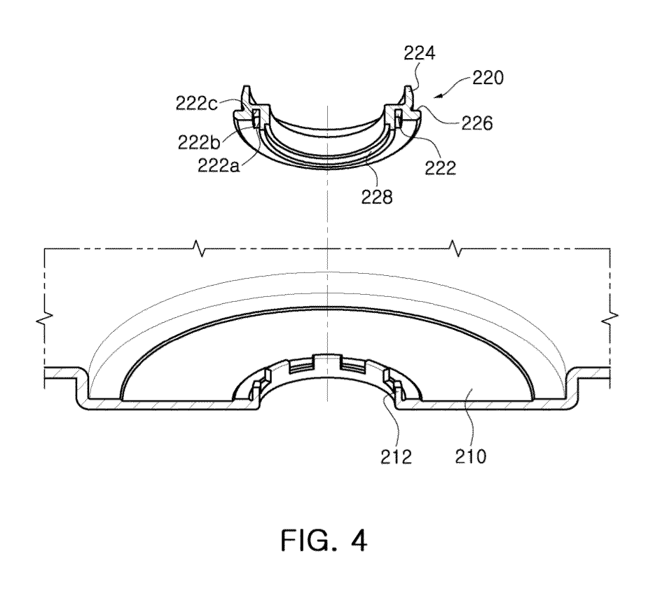

FIG. 4 is a bottom perspective view showing an installation member provided in a spindle motor according to another exemplary embodiment of the present disclosure.

Referring to FIG. 4, an installation member 220 may have an insertion groove 222 formed therein, wherein the insertion groove 222 has the bend portion 112 (See FIG. 1) inserted thereinto. The insertion groove 222 may be recessed from a lower surface of the installation member 220 in the upward axial direction. Meanwhile, the bend portion 112 of the base member 110 (See FIG. 1) may contact at least two of an inner wall surface 222a, an outer wall surface 222b, and a ceiling surface 222c of the installation member 220 forming the insertion groove 222. In addition, the bend portion 112 may be fixed to the insertion groove 222 of the installation member 220 by the adhesive.

As described above, since the bend portion 112 is inserted into and coupled to the insertion groove 222 formed in the installation member 220, the bend portion 112 and the installation member 220 may be bonded to each other on at least two surfaces, such that coupling force between the installation member 220 and the base member 110 may be increased.

In other words, the inner peripheral surface and the outer peripheral surface of the bend portion 112 may be bonded to the inner wall surface 222a and the outer wall surface 222b of the installation member 220, respectively, such that a bonded area is increased, thereby increasing the coupling force.

Meanwhile, a plurality of insertion grooves 222 may be disposed so as to be spaced apart from each other in the circumferential direction. That is, the plurality of insertion grooves 222 may be formed, and the bend portions 122 may be formed so as to correspond to the insertion grooves 222.

As described above, the plurality of insertion grooves 222 and bend portions 112 are provided, whereby an influence of the bend portion 112 on perpendicularity of the shaft 130 (See FIG. 1) may be further decreased.

In addition, the installation member 220 may have the stator core 102 (See FIG. 1) fixed thereto. To this end, the installation member 220 may include a support wall part 224 supporting an inner diameter part of the stator core 102 and a support surface 226.

That is, the stator core 102 may be installed on the installation member 220 through an adhesive in a state in which it is seated on the support surface 226.

In addition, an inner peripheral surface of the installation member 220 may have a roughness rougher than those of other portions. That is, the inner peripheral surface of the installation member 220 may be bonded to the outer peripheral surface of the sleeve 130 (See FIG. 1) by the adhesive, and may be formed so as to have a rough roughness in order to increase coupling force between the installation member 220 and the sleeve 130.

Therefore, the coupling force between the sleeve 130 and the installation member 220 may be increased.

In addition, the installation member 220 may have a bonding groove 228 formed at a lower end portion of an inner diameter part thereof in order to be bonded to the sleeve 130. The bonding groove 228 may have a solder ball inserted thereinto at the time of welding the installation member 120 and the sleeve 130 to each other.

That is, the installation member 220 and the sleeve 130 may be coupled to each other by the adhesive and the welding. In other words, the inner peripheral surface of the installation member 220 may be bonded to the outer peripheral surface of the sleeve 130 by the adhesive, and lower surfaces of the installation member 220 and the sleeve 130 may be bonded to each other by the welding.

Hereinafter, a recording disk driving apparatus according to an exemplary embodiment of the present disclosure will be described with reference to the accompanying drawings.

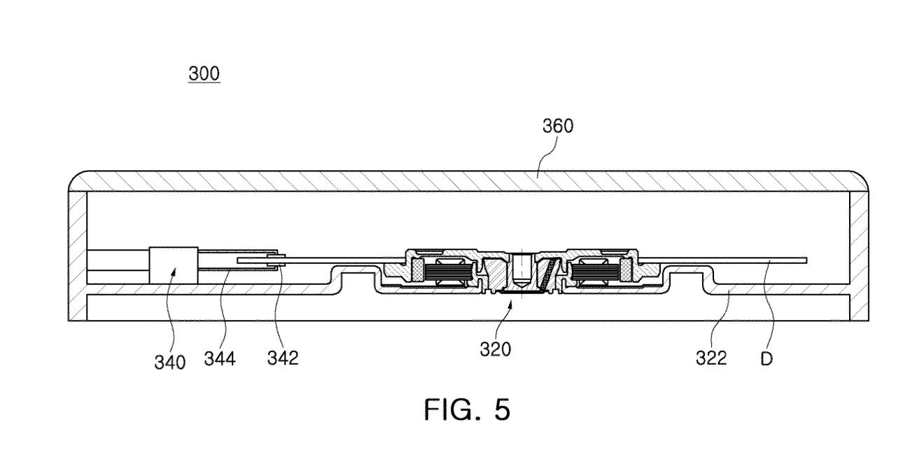

FIG. 5 is a schematic cross-sectional view showing a recording disk driving apparatus according to an exemplary embodiment of the present disclosure.

Referring to FIG. 5, a recording disk driving apparatus 300 according to an exemplary embodiment of the present disclosure may include a spindle motor 320, a head transfer part 340, and an upper case 360 by way of example.

The spindle motor 320 may be any one of the spindle motors according to an exemplary embodiment and another exemplary embodiment of the present disclosure described above, and may have a recording disk D mounted thereon.

The head transfer part 340 may transfer a head 342 detecting information of the recording disk D mounted on the spindle motor 320 to a surface of the recording disk D of which the information is to be detected. The head 342 may be disposed on a support part 344 of the head transfer part 340.

The upper case 360 may be coupled to a base member 322 in order to form an internal space accommodating the spindle motor 320 and the head transfer part 340 therein.

As set forth above, according to exemplary embodiments of the present disclosure, the bend portion of the base member may be inserted into the insertion groove of the installation member, whereby separation of the installation member may be decreased.

In addition, the bend portion may be inserted into the insertion groove of the installation member, whereby a working tolerance of the bend portion by the base member formed by the press may be decreased.

While exemplary embodiments have been shown and described above, it will be apparent to those skilled in the art that modifications and variations could be made without departing from the scope of the present invention as defined by the appended claims.

What is claimed is:

1. A spindle motor comprising:
a base member including a bend portion;
an installation member having an insertion groove formed therein and a stator core fixed thereto, the insertion groove having the bend portion inserted thereinto; and
a sleeve fixed to an inner peripheral surface of the installation member.

2. The spindle motor of claim 1, wherein the insertion groove is recessed from a lower surface of the installation member in an upward axial direction.

3. The spindle motor of claim 1, wherein the bend portion is bonded to an inner wall surface, an outer wall surface, and a ceiling surface forming the insertion groove.

4. The spindle motor of claim 1, wherein the installation member has a bonding groove formed in a lower end portion of an inner diameter part thereof in order to be bonded to the sleeve.

5. The spindle motor of claim 4, wherein the sleeve has a step groove formed in a lower end portion of an outer peripheral surface thereof, the step groove being welded together with the bonding groove.

6. The spindle motor of claim 1, wherein the inner peripheral surface of the installation member has a roughness rougher than those of other portions.

7. The spindle motor of claim 1, further comprising:
a shaft inserted into a shaft hole of the sleeve;
a rotor hub fixed to an upper end portion of the shaft to thereby be rotated together with the shaft; and
a cover member installed at a lower end portion of the sleeve and preventing leakage of a lubricating fluid.

8. The spindle motor of claim 1, wherein the installation member is bonded to the base member through an adhesive.

9. The spindle motor of claim 1, wherein the bend portion has an adhesive accommodating groove formed in a lower end portion thereof in order to accommodate an adhesive therein.

10. A recording disk driving apparatus comprising:
the spindle motor of claim 1 rotating a recording disk;
a head transfer part transferring a head reading information from and writing information to the recording disk mounted on the spindle motor; and
an upper case coupled to the base member provided in the spindle motor so as to form an internal space accommodating the spindle motor and the head transfer part therein.
